(19) United States
(12) Patent Application Publication
(10) Pub. No.: US 2025/0148254 A1
(43) Pub. Date: May 8, 2025

(54) A LABEL-IN-MOLD AND METHOD THEREOF

(71) Applicant: TADBIK ADVANCED TECHNOLOGIES LTD., Petach Tikva (IL)

(72) Inventor: Guy GOLDBERG, Herzelia (IL)

(21) Appl. No.: 19/014,382

(22) Filed: Jan. 9, 2025

Related U.S. Application Data
(63) Continuation-in-part of application No. PCT/IL2023/050718, filed on Jul. 10, 2023.

(30) Foreign Application Priority Data
Jul. 10, 2022 (IL) 294628

(51) Int. Cl. G06K 19/077; B32B 7/12; B32B 27/08

(52) U.S. Cl. CPC G06K 19/07722; B32B 7/12; B32B 27/08; B32B 2255/10; B32B 2307/7376; B32B 2519/02

(57) ABSTRACT

The present invention discloses an in-mold label configured to be inserted in a mold, and method for manufacturing the same. The in-mold label comprising an outer layer, an inlay layer configured to perform as a passive electronic communication unit and an outer layer. The material forming the outer layer and the inner layer are selected to bond integrally with the material used for a molded plastic product.

### CROSS REFERENCE

This application is a Continuation in Part of PCT Patent Application No. PCT/IL2023/050718 having International filing date of Jul. 10, 2023, which claims the benefit of priority Israel Patent Application No. 294628, filed Jul. 10, 2022, the contents of which are all incorporated herein by reference in their entirety.

### FIELD OF THE INVENTION

The invention is in the field of in-mold labels and the method of production thereof.

### BACKGROUND OF THE INVENTION

EP patent EP1873693A2 discloses a decorative or exhibitive surface element with a lithographic imprint that is manufactured by means of in-mold labeling (IML) process, comprises a planar base structure, an identification element, and a first- and a second lateral surface. The first lateral surface is adapted for binding the surface of a molding that is injection molded from a plasticized in-mold molding compound to form an injection molding. The second lateral surface is adapted along with the molding as a composite to form a part of the surface of the injection molding. The decorative or exhibitive surface element with a lithographic imprint that is manufactured by means of in-mold labeling (IML) process, comprises a planar base structure, an identification element, and a first- and a second lateral surface. The first lateral surface is adapted for binding the surface of a molding that is injection molded from a plasticized in-mold molding compound to form an injection molding. The second lateral surface is adapted along with the molding as a composite to form a part of the surface of the injection molding. The base structure is composed of a material that at temperatures below the temperature of the plasticized in-mold molding compound, exhibits uniform after-shrinkage and processing shrinkage characteristics as that of the in-mold molding compound of the molding. The identification element is adapted to the contact-free and optically contact-free identification and comprises a signal receiver element and a circuit element that are suitable for the wireless data transmission with an external reading system. Fillers are contained in the material of the base structure at a proportion of 60 wt. %. The identification element is directly connected to the surface of the base structure and a part of the surface of the signal receiver element forms a freely lying part of the contact surface of the in-mold surface element. The signal receiver element is made of conductive lacquer. The identification element is designed as radio-frequency identification (RFID) transponder. The circuit element is designed as an integrated circuit, which is in conjunction with the signal receiver element embedded in a heat-proofing mass.

The second lateral surface has another identification element for optical identification. The surface of the further identification element has a bar code. An independent claim is included for injection molding with an in-mold surface element.

However, before the IML is embedded into the injection molded part, the antenna is unprotected, so that damage to the antenna is possible during storage or handling before the antenna is embedded in the injection molded part.

EPO patent EP2231379B1 describes a method for attaching a radio frequency identification tag to an article, more particularly, a container suitable for use in a diagnostic instrument. by means of an insert molding process or an in-mold decorating process. The method can be utilized to simplify the manufacturing processes for applying a radio frequency identification tag to an object, e.g., a container. The molding process can be a conventional molding process, such as, for example, injection molding, blow molding, compression molding, transfer molding, and rotational molding. However, the conventional molding process is modified by inserting a radio frequency identification tag into the cavity of the mold prior to forming the molded article. The modified molding process results in a molded article having a radio frequency identification tag encapsulated by the polymeric material of the molded article.

However, before the IML is embedded into the injection molded part, the antenna is unprotected, so that damage to the antenna is possible during handling before the antenna is embedded in the injection molded part. Furthermore, EP2231379B1 does not teach an optically-readable outer layer protected by a cover layer. In addition, a radiation-curable adhesive is required to adhere the antenna to the RFID tag, which is supplied on a roll.

US application US2008/0150701A1 teaches an apparatus for injection molding plastic articles with integral RFID tags. The apparatus includes an injection molding machine comprising a melt reservoir, a plunger, heating elements, an injection nozzle, a hot runner passageway, a mold having at least one mold cavity, and an RFID injection element having a valve and an RFID hopper. The method for creating injection molded plastic articles having integrally molded RFID tags includes injecting an RFID tag into liquid plastic resin during the injection molding process.

However, US2008/0150701A1 teaches how to generate the plastic article, but does not teach, suggest or motivate any method or apparatus for generating the RFID tag itself.

US patent U.S. Pat. No. 8,097,199B2 relates to a method of making a plastic container having an RFID tag in a wall of the container includes providing a mold having a mold core and mounting an insert on the core. The insert includes an RFID tag Surrounded by a plastic housing, which preferably is retained on the core for example by heat of the core partially melting the housing. A plastic preform is formed in the mold around the core and the insert, preferably by injection molding, such that the insert is embedded in a wall of the preform. The preform is then blow molded into a plastic container having the insert embedded in a wall of the container. The insert preferably is mounted on an end of the core such that the insert is in the base wall of the container following blow molding. The RFID tag preferably is externally covered by plastic material in the preform as molded, and in the container as blow molded, so that the RFID tag is not externally exposed in the preform or the container. The disclosure also contemplates a container preform and a molded plastic container manufactured in accordance with a method of the disclosure.

The RFID tag of U.S. Pat. No. 8,097,199, comprising an antenna and an RFID tag, is insert molded into a plastic housing. The RFID tag is then embedded on the inner side of a blow-molded object. However, U.S. Pat. No. 8,097,199 does not teach suggest or motivate any method or apparatus for generating the RFID tag itself.

US patent U.S. Pat. No. 7,017,822B2 discloses RFID antennas formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel-plated carbon fiber, stainless steel fiber, copper fiber, silver fiber, or the like. The RFID antenna is molded of conductive loaded resin-based material where the antenna characteristics can be altered or the visual characteristics can be altered by forming a metal layer over the conductive loaded resin-based material.

However, U.S. Pat. No. 7,017,822 teaches a stand-alone RFID tag, and does not teach configuring the RFID tag to be embedded in a molded product. Furthermore, the RFID tag is a molded product, rather than being formed from laminated or adhered sheet.

US patent U.S. Pat. No. 9,908,271B2 discloses the production of a plastic container by introducing a planar electronic element, a planar electronic element into a recess (of an inner face of a mold. The mold comprises an outer mold part and a mold core, which form a mold cavity. Molten plastic material is injected into the mold cavity. After the subsequent cooling of the plastic material, mold removal is carried out. The recess is arranged on an inner face of the outer mold part. The molten plastic material is injected into the mold cavity in such a way that the molten plastic material flows substantially parallel along a surface of the planar electronic element facing the mold cavity. The planar electronic element is an RFID inlay, for example. The planar electronic element does not require a protective casing and can be sprayed directly

However, U.S. Pat. No. 9,908,271 does not teach any optically-readable layer, nor does it teach any protective plastic layer for the RFID tag to support the RFID and enable storage and handling of the RFID tag before embedding of the RFID tag in a molded product. In addition, the protection for the RFID is molded rather than a sheet.

US patent U.S. Pat. No. 8,118,232B2 discloses a manufacturing method of products attached with a RFID label in a mold includes a first step of forming a thin substratum by injecting molding, pushing molding, vacuum molding, blowing molding or sword molding in a first mold, a second step of making a substratum label composed of the substratum and an RFID label adhered with the substratum, and a third step of placing the substratum label in a second mold, in which a plastic product is to be formed and also to be attached with the substratum label inside the product during molding process. The RFID cannot be broken or damaged to always maintain its capacity to be identified, with the plastic product enhanced in its value.

However, U.S. Pat. No. 8,118,232B2 discloses a molded substratum, and does not disclose how the RFID label is generated.

US patent U.S. Pat. No. 9,258,898B2 discloses an embedded electronic device and a method for manufacturing the same wherein the embedded electronic device is composed of a printed circuit board, having a top surface and a bottom surface, a plurality of circuit components attached to the top surface of the printed circuit board having a plurality of stand offs on the bottom surface of the printed circuit board, a bottom overlay attached to the bottom surface of the printed circuit board, a top overlay positioned above the top surface of the printed circuit board and a core layer positioned between the top surface of the printed circuit board and the top overlay

However, U.S. Pat. No. 9,258,898B2 discloses a stand-alone tag, and does not teach configuring the RFID tag to be embedded in a molded product. Furthermore, the tag comprises a printed circuit board, rather than a flexible sheet as a base for the electronics.

Therefore, there exists a long felt need for a mold-in-place label that provides an optically readable layer protected by a cover layer, that protects the RFID tags before use, enabling them to be stored and handled without damage, and that protects the RFID tags from delamination during use, especially heavy use.

### SUMMARY OF THE INVENTION

It is an object of the present invention to present a method of producing a label to be inserted in a mold, comprising steps of:
a. obtaining an outer layer, the outer layer comprising a film or sheet;
b. printing visual data on an outer side of the outer layer;
c. obtaining an inner support film;
d. placing an electronic circuit on the inner support film, thereby generating an inner layer;
e. applying a pressure-sensitive adhesive to the inner layer;
f. placing together the inner layer and the outer layer with the pressure-sensitive adhesive therebetween; and
g. bonding together the inner layer to the outer layer;
wherein the outer layer film or sheet and the inner support film are configured to bond integrally with a product formed by a plastic injectable into the mold.

It is another object of the present invention to present the method of producing a label as presented in any of the above, additionally comprising a step of providing a protective layer on an external side of the outer layer.

It is another object of the present invention to present the method of producing a label as presented in any of the above, additionally comprising a step of selecting the protective layer from a group consisting of a varnish or a protective sheet laminated to the external side.

It is another object of the present invention to present the method of producing a label as presented in any of the above, additionally comprising a step of providing the adhesive stable at temperatures up to at least 140° C.

It is another object of the present invention to present the method of producing a label as presented in any of the above, additionally comprising a step of selecting the pressure-sensitive adhesive from a group consisting of an acrylic pressure sensitive adhesive, a rubber-based pressure sensitive adhesive or a silicone-based pressure sensitive adhesive.

It is another object of the present invention to present the method of producing a label as presented in any of the above, additionally comprising a step of providing each of the outer layer and the inner layer having a thickness of at least 150 μm.

It is another object of the present invention to present the method of producing a label as presented in any of the above, additionally comprising a step of providing each of the outer layer and the inner layer having a minimum thickness of 250 μm.

It is another object of the present invention to present the method of producing a label as presented in any of the above, additionally comprising a step of providing the inner layer and the outer layer material compatible with plastic injected into the mold to generate a molded product.

It is another object of the present invention to present the method of producing a label as presented in any of the above, additionally comprising a step of providing the outer layer and the inner layer comprising material selected from a group consisting of HDPE, PP, PE, ABS, PC, PA, PC, PET and TPU.

It is another object of the present invention to present the method of producing a label as presented in any of the above, additionally comprising a step of selecting the visual data from a group consisting of a graphic, a printed word, a barcode, a data matrix code, or any combination thereof.

It is another object of the present invention to present the method of producing a label as presented in any of the above, additionally comprising a step of configuring the electronic circuit as an electronic communication unit.

It is another object of the present invention to present the method of producing a label as presented in any of the above, additionally comprising a step of providing the electronic communication unit comprising an antenna and an integrated circuit (IC).

It is another object of the present invention to present the method of producing a label as presented in any of the above, additionally comprising a step of providing the electronic circuit characterizable as RFID or BLE.

It is another object of the present invention to present the method of producing a label as presented in any of the above, additionally comprising a step of providing the electronic circuit as a separate layer.

It is another object of the present invention to present the method of producing a label as presented in any of the above, additionally comprising a step of bonding the separate layer to either the inner layer or the outer layer.

It is another object of the present invention to present the method of producing a label as presented in any of the above, additionally comprising a step of characterizing the separate layer by having a thickness that is less than 20 u and having a minimum deflection temperature of 130° C.

It is another object of the present invention to present a method of producing a product with a mold-in label, comprising steps of:
a. obtaining a mold-in label generated by a method comprising steps of:
   i. obtaining an outer layer, the outer layer comprising a film or sheet;
   ii. printing visual data on an outer side of the outer layer;
   iii. obtaining an inner support film;
   iv. placing an electronic circuit on the inner support film, thereby generating an inner layer;
   V. applying a pressure-sensitive adhesive to the inner layer;
   vi. placing together the inner layer and the outer layer with the pressure sensitive adhesive therebetween; and
   vii. bonding together the inner layer and the outer layer;
b. positioning the mold-in label in a mold;
c. adding a melted plastic to the mold;
d. cooling the plastic; and
e. removing the molded product from the mold;
wherein the outer layer film or sheet and the inner layer film or sheet are configured to bond integrally with the molded part.

It is another object of the present invention to present the method of producing a product with a mold-in label as presented in any of the above, additionally comprising a step of holding the mold-in label in the mold.

It is another object of the present invention to present the method of producing a product with a mold-in label as presented in any of the above, additionally comprising a step of holding the label by generating vacuum, static electricity or both between the mold-in label and the mold.

It is another object of the present invention to present the method of producing a product with a mold-in label as presented in any of the above, additionally comprising a step of providing the pressure-sensitive adhesive as a pressure-sensitive film.

It is another object of the present invention to present the method of producing a product with a mold-in label as presented in any of the above, additionally comprising a step of providing the adhesive stable at temperatures up to at least 140° C.

It is another object of the present invention to present the method of producing a product with a mold-in-label as presented in any of the above, additionally comprising a step of selecting the pressure-sensitive adhesive from a group consisting of an acrylic pressure sensitive adhesive, a rubber-based pressure sensitive adhesive or a silicone-based pressure sensitive adhesive.

It is another object of the present invention to present the method of producing a product with a mold-in label as presented in any of the above, additionally comprising a step of providing each of the outer layer and the inner layer having a minimum thickness of 150 μm.

It is another object of the present invention to present the method of producing a product with a mold-in label as presented in any of the above, additionally comprising a step of providing each of the outer layer and the inner layer having a minimum thickness of 200 μm.

It is another object of the present invention to present the method of producing a product with a mold-in-label as presented in any of the above, additionally comprising a step of providing the outer layer and the inner layer comprising material compatible with the plastic.

It is another object of the present invention to present the method of producing a product with a mold-in-label as presented in any of the above, additionally comprising a step of providing the outer layer and the inner layer comprising material selected from a group consisting of HDPE, PP, PE, ABS, PC, PA, PC, PET and TPU.

It is another object of the present invention to present the method of producing a product with a mold-in-label as presented in any of the above, additionally comprising a step of selecting the visual data from a group consisting of a graphic, a printed word, a barcode, a data matrix code or any combination thereof.

It is another object of the present invention to present the method of producing a product with a mold-in-label as presented in any of the above, additionally comprising a step of providing a protective layer on an external side of the outer layer.

It is another object of the present invention to present the method of producing a product with a mold-in-label as presented in any of the above, additionally comprising a step of selecting the protective layer from a group consisting of a varnish or a protective sheet laminated to the external side of the outer layer.

It is another object of the present invention to present the method of producing a product with a mold-in-label as presented in any of the above, additionally comprising a step of configuring the electronic circuit as an electronic communication unit.

It is another object of the present invention to present the method of producing a product with a mold-in-label as presented in any of the above, additionally comprising a step of providing the electronic communication unit comprising an antenna and an integrated circuit (IC).

It is another object of the present invention to present the method of producing a product with a mold-in-label as presented in any of the above, additionally comprising a step of providing the electronic communication unit characterizable as RFID, BLE or both.

It is another object of the present invention to present a label for inserting in a mold, comprising:
a. an outer layer comprising visual data, the outer layer comprising a film or sheet;
b. an inner support layer comprising a film or sheet; and
c. an electronic circuit, therebetween, the electronic circuit either (i) bonded to the outer layer and adhered by means of a pressure-sensitive adhesive to the inner support layer or (ii) bonded to the inner support layer and adhered by means of a pressure-sensitive adhesive to the outer layer;
wherein the outer layer film or sheet and the inner layer film or sheet are configured to bond integrally with a product formed by a plastic injectable into the mold.

It is another object of the present invention to present the label for inserting in a mold, as presented in any of the above, wherein the first layer comprises a protective layer on an external side of the outer layer.

It is another object of the present invention to present the label for inserting in a mold, as presented in any of the above, wherein the protective layer is selected from a group consisting of a varnish or a protective sheet laminated to the external side.

It is another object of the present invention to present the label for inserting in a mold, as presented in any of the above, wherein the pressure-sensitive adhesive is stable at temperatures up to at least 140° C.

It is another object of the present invention to present the label for inserting in a mold, as presented in any of the above, wherein the pressure-sensitive adhesive is selected from a group consisting of an acrylic pressure sensitive adhesive, a rubber-based pressure sensitive adhesive or a silicone-based pressure sensitive adhesive.

It is another object of the present invention to present the label for inserting in a mold, as presented in any of the above, wherein each of the inner support layer and the outer layer have a minimum thickness of 150 μm.

It is another object of the present invention to present the label for inserting in a mold, as presented in any of the above, wherein each of the inner support layer and the outer layer have a minimum thickness of 200 μm.

It is another object of the present invention to present the label for inserting in a mold, as presented in any of the above, wherein the inner support layer and the outer layer comprise a material compatible with a plastic injectable into the mold.

It is another object of the present invention to present the label for inserting in a mold, as presented in any of the above, wherein the inner support layer and the outer layer comprise material selected from a group consisting of HDPE, PP, PE, ABS, PC, PA, PC and PET.

It is another object of the present invention to present the label for inserting in a mold, as presented in any of the above, wherein the visual data is selected from a group consisting of a graphic, a printed word, a barcode, a matrix code or any combination thereof.

It is another object of the present invention to present the label for inserting in a mold, as presented in any of the above, wherein the electronic circuit comprises an electronic communication unit.

It is another object of the present invention to present the label for inserting in a mold, as presented in any of the above, wherein the electronic communication unit comprises an antenna and an integrated circuit (IC).

It is another object of the present invention to present the label for inserting in a mold, as presented in any of the above, wherein the electronic communication unit additionally comprises a battery.

It is another object of the present invention to present the label for inserting in a mold, as presented in any of the above, wherein the electronic communication unit is characterized as RFID or BLE.

It is another object of the present invention to present the label for inserting in a mold, as presented in any of the above, wherein the outer layer has a border on all four sides of the inner layer.

It is another object of the present invention to present the label for inserting in a mold, as presented in any of the above, wherein the border is at least 3 mm wide on all four sides of the inner layer.

It is another object of the present invention to present the label for inserting in a mold, as presented in any of the above, wherein the inner layer has a smaller surface area than the outer layer.

It is another object of the present invention to present the label for inserting in a mold, as presented in any of the above, wherein the surface area of the inner layer is no more that 95% of the surface area of the outer layer.

It is another object of the present invention to present the label for inserting in a mold, as presented in any of the above, wherein the antenna has a smaller surface area than the inner layer.

It is hence an object of the present invention to disclose a method for manufacturing an in-mold label (IML) using a continuous roll to roll process, the method comprising steps of: (a) obtaining an outer layer, the outer layer comprising a film or sheet, characterized by a thickness of between 200 μm and 1000 μm; (b) printing visual data on an outer side of the outer layer; (c) obtaining an inner support layer comprising a film or sheet, characterized by a thickness of between 200 μm and 1000 μm; (d) placing an inlay layer configured to perform as a passive electronic communication unit, characterized by a thickness of between 100 μm and 350 μm; (e) applying a pressure-sensitive adhesive to the inner and outer layers, characterized by a thickness of between 80 and 150 microns; (f) placing together the inner layer, the inlay layer and the outer layer with the pressure sensitive adhesive there between; and (g) bonding together all layers, thereby obtaining the IML, a label to be inserted in a mold; the outer layer film or sheet and the inner support film are configured to bond integrally with a product formed by a plastic injectable into the mold; wherein the inlay layer comprises: (i) at least two electronic components independently selected for the group consisting of radio-frequency identification integrated circuit (RFID-IC), near-field communication integrated circuit (NFC-IC), Bluetooth low energy integrated circuit (BLE-IC), or a capacitor; (ii) an antenna supporting layer comprising an antenna; (iii) a supporting layer; and a pressure-sensitive adhesive layer configured to connect between the antenna supporting layer and the supporting layer.

In some embodiments, the printing further comprises printing invisible data, color changing materials, or both; configured to enable package identification, monitor environmental changes, or both.

In some embodiments, the method further comprising a step of providing a protective layer on an external side of the outer layer, selected from a group consisting of a varnish or a protective sheet laminated to the external side.

In some embodiments, the pressure-sensitive adhesive is stable at temperatures up to at least 140° C., selected from a group consisting of an acrylic pressure sensitive adhesive, a rubber-based pressure sensitive adhesive or a silicone-based pressure sensitive adhesive, including any combination thereof, or both.

In some embodiments, the outer layer and the inner layer comprise materials compatible with plastic injected into a mold to generate a molded product selected from a group consisting of high-density polyethylene (HDPE), polypropylene (PP), polyethylene (PE), acrylonitrile butadiene styrene (ABS), polycarbonate (PC), polyamide (PA), polyethylene terephthalate (PET), or thermoplastic polyurethane (TPU) including any combination thereof.

In some embodiments, the visual data is selected from a group consisting of a graphic, a printed word, a barcode, a data matrix code or any combination thereof.

In some embodiments, the method further comprising preparing the inlay layer by preparing the antenna supporting layer comprising the antenna; preparing or obtaining a supporting layer; and connecting between the antenna supporting layer with the antenna and connecting the antenna with the supporting layer.

In some embodiments, the antenna is characterized by a thickness between 8 μm and 20 μm, a minimum deflection temperature of 130° C., or both.

In some embodiments, the outer layer fully surrounds the inner layer and forms a border characterized by a width of at least 3 mm on all four sides of the inner layer.

In some embodiments, the outer layer is larger than the inner layer, the difference in size selected from a group consisting of (i) the inner layer has a smaller surface area than the outer layer; or (ii) the surface area of the inner layer is no more that 95% of a surface area of the outer layer.

In some embodiments, the antenna has a smaller surface area than the inner layer.

It is hence another object of the invention to disclose a label for inserting in a mold comprising: (a) an outer layer comprising visual data, film or sheet, the outer layer characterized by a thickness of between 200 μm and 1000 μm; (b) an inner support layer comprising a film or sheet, characterized by a thickness of between 200 μm and 1000 μm; (c) an inlay layer configured to perform as a passive electronic communication unit, characterized by a thickness of between 100 μm and 350 μm; the outer layer, inlay layer and inner support layer are adhered to one another by pressure-sensitive adhesive; and the outer layer film or sheet and the inner support film are configured to bond integrally with a product formed by a plastic injectable into a mold; wherein the inlay layer comprises (i) at least one electronic components independently selected for the group consisting of radio-frequency identification integrated circuit (RFID-IC), near-field communication integrated circuit (NFC-IC), Bluetooth low energy integrated circuit (BLE-IC), or a capacitor; (ii) an antenna supporting layer comprising an antenna; (iii) a supporting layer; and (iv) a pressure-sensitive adhesive layer configured to connect between the antenna supporting layer and the supporting layer.

In some embodiments, the outer layer comprises invisible data, color changing materials, or both; configured to enable package identification, monitor environmental changes, or both.

In some embodiments, external side of the outer layer comprises a protective layer selected from a group consisting of a varnish or a protective sheet laminated to the external side.

In some embodiments, the pressure-sensitive adhesive is stable at temperatures up to at least 140° C., selected from a group consisting of an acrylic pressure sensitive adhesive, a rubber-based pressure sensitive adhesive or a silicone-based pressure sensitive adhesive, including any combination thereof, or both.

In some embodiments, the inlay layer is obtained by preparing the antenna supporting layer comprising the antenna; and connecting between the antenna supporting layer with the supporting layer.

In some embodiments, the antenna is characterized by a thickness between 8 μm and 20 μm, a minimum deflection temperature of 130° C., or both.

In some embodiments, the outer layer fully surrounds the inner layer and forms a border characterized by a width of at least 3 mm on all four sides of the inner layer.

In some embodiments, the outer layer is larger than the inner layer, the difference in size selected from a group consisting of (i) the inner layer has a smaller surface area than the outer layer; or (ii) the surface area of the inner layer is no more that 95% of a surface area of the outer layer.

In some embodiments, the antenna has a smaller surface area than the inner layer.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention wherein:

FIG. 1A-C presents a schematic representation of the label of the present invention;

FIG. 2 presents a method for the construction of the label of the present invention;

FIG. 3 presents a method for the construction of the label of the present invention; and

FIG. 4 presents a method for the construction of the label of the present invention;

FIG. 5A-B schematically illustrates an embodiment of an attachable RFID;

FIG. 6 schematically illustrates an embodiment of an outer layer;

FIG. 7A-B schematically illustrates an embodiment of an assembled RFID tag;

FIG. 8 schematically illustrates an embodiment of an exemplary RFID tag;

FIG. 9 presents an illustration representing an in-mold label composition and configuration according to some embodiments of the present invention;

FIG. 10 presents an illustration of inlay layer according to some embodiments of the present invention;

FIG. 11 presents an illustration of an outer layer for PP or PE injected parts according to some embodiments of the present invention;

FIG. 12. presents an illustration of a side view of an IML according to some embodiments of the present invention.

### DETAILED DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods.

In this application the term “Radio-frequency identification (RFID)” refers to an identification system that uses electromagnetic fields to automatically identify at item with a label (or tag). In many embodiments, an RFID system consists of a radio receiver, a (tiny) radio transponder and transmitter. When triggered by an electromagnetic interrogation pulse from a nearby RFID reader, the tag transmits a signal comprising digital data, such as an identifying inventory number, to the reader. This system can enable the rapid identification and tracking of items and containers.

RFID labels can be characterized as active or passive. Passive tags are powered by energy of the radio waves, emitted by the RFID reader. Active tags additionally comprise a power source (such as a battery) and can therefore be read by the RFID reader at much greater ranges (up to hundreds of meters).

As used herein, the term “thermoplastic” (or “thermosoftening plastic”) refers to a plastic or polymer material that becomes pliable (and therefore moldable) when heated at or above a certain temperature and solidifies upon cooling. The thermoplastic polymer could be HDPE, PP, PE, ABS, PC, PA, PC, PET or TPU.

As used herein, the term “PE” refers to polyethylene (or polythene), a commonly used thermoplastic polymer. “HDPE” (or PEHD) refers to High-density polyethylene (or polyethylene high-density)

Unless otherwise stated, with reference to numerical quantities, the term “about” refers to a tolerance of ±25% of the stated nominal value.

Unless otherwise stated, all numerical ranges are inclusive of the stated limits of the range.

The present application is directed to an in-mold label (IML) that is placeable in a plastic injection mold configured to produce an object. The IML is held in position in the plastic injection mold by vacuum and/or by static electricity). After positioning of the IML, the mold is closed and a plastic melt is injected into the mold, thereby generating the product. After completing the cooling cycle, the product is ejected from the mold, with the product being an object comprising the IML as an intrinsic part thereof.

In some embodiment, the in-mold layer (IML) comprises at least two electronic components. In some embodiments, the at least two electronic components are independently selected from the group consisting of radio-frequency identification integrated circuit (RFID-IC), near-field communication integrated circuit (NFC-IC), Bluetooth low energy integrated circuit (BLE-IC), or a capacitor.

According to another aspect of the present invention there is provided a method for manufacturing an in-mold label (IML), comprising steps of (i) obtaining an outer layer; (ii) printing visual data on an outer side of the outer layer; (iii) obtaining an inner support layer; (iv) placing an inlay layer; (v) applying a pressure-sensitive adhesive; (vi) placing together the inner layer the inlay layer and the outer layer with the pressure sensitive adhesive there between; and (vii) bonding together all layers, thereby obtaining a label to be inserted in a mold, wherein the inlay layer comprises (i) at least two electronic components; (ii) an antenna supporting layer comprising an antenna; and (iii) a pressure-sensitive layer configured to connect between the antenna supporting layer and the supporting layer. In some embodiments, the method utilizes a continuous roll to roll process. In some embodiments, the outer layer film or sheet and the inner support film are configured to bond integrally with a product formed by a plastic injectable into the mold.

Reference is now made to FIG. 9 illustrating an IML composition and configuration according to some embodiments of the present invention. The IML is manufactured in continuous roll to roll where the injection direction is demonstrated by the arrow. The IML comprises of an outer layer 300 which is adhered to an inlay layer 340 by a pressure-sensitive adhesive 320, and an inner layer 350 adhered to inlay layer 340 by a pressure-sensitive adhesive 320. In some embodiments, the pressure-sensitive adhesive 320 is characterized by a thickness of between 80 μm and 150 μm, between 100 μm and 150 μm, between 100 μm and 140 μm, or between 120 μm and 140 μm, including any range or value in between. Each possibility represents a separate embodiment of the present invention.

In some embodiments, the outer layer is or comprises a film or a sheet. As used herein, the terms “sheet” and “film” refer to thin flat materials. film is typically characterized by a thickness less than 250 μm, and sheet is typically characterized by thickness greater than 250 μm.

In some embodiments, the outer layer is characterized by a thickness of between 200 μm and 1000 μm, between 200 μm and 800 μm, between 300 μm between 700 μm, between 350 μm and between 650 μm, between 350 μm and 550 μm, or between 400 and 500 μm, including any range or value in between. Each possibility represents a separate embodiments of the present invention.

In some embodiments, printing is on the outer side of the outer layer. In some embodiments, printing is selected from the group consisting of: visual data, invisible data, or color changing materials, including any combination thereof.

In some embodiments, visual data is selected from a group consisting of a graphic, a printed word, a barcode, a data matrix code or any combination thereof. A person skilled in the art would appreciate that visual data in labeling serves multiple purposes, including branding, communication, functionality, sustainability, and compliance. Functional elements such as barcodes, QR codes, and holograms aid in product tracking, authentication, and usability. Additionally, visual cues highlight sustainability credentials, such as recycling symbols, while meeting regulatory requirements for labels and warnings. Overall, visual data ensures packaging is informative, appealing, and compliant with consumer and legal expectations.

In some embodiments, invisible data and color changing materials are configured to enable package identification, authorization, or monitor environmental changes, including any combination thereof. A person skilled in the art would appreciate that invisible data labeling leverages anonymizing sensitive information, it ensures privacy or can prevent counterfeiting.

Non-limiting examples of color-changing materials include but are not limited to thermochromic materials, photochromic materials, electrochromic materials, mechanochemical and piezochromic materials, solvatochromic and chemichromic materials, or fluorescent and phosphorescent materials, including any combination thereof.

As used herein, the term “color-changing materials” refer to substances that alter their color in response to external stimuli such as temperature, light, electricity, mechanical stress, or chemical interactions, including any combination thereof. These materials can be reversible or irreversible, enabling diverse applications in smart devices, responsive textiles, safety systems, and interactive consumer products.

In some embodiments, external side of the outer layer is coated with a protective layer. In some embodiments, the protective layer is or comprises a varnish. In some embodiments, the protective layer is or comprises a laminated protective sheet to the external side of the outer layer. In some embodiments, the protective layer is characterized by a thickness of 5-50 μm.

In some embodiments, the inner support layer is or comprises a film or a sheet. In some embodiments, the inner support layer is characterized by a thickness of between 200 μm and 1000 μm, between 200 μm and 800 μm, between 300 μm between 700 μm, between 350 μm and between 650 μm, between 350 μm and 550 μm, or between 400 and 500 μm, including any range or value in between. Each possibility represents a separate embodiment of the present invention.

In some embodiments, the outer layer and the inner layer comprise materials compatible with plastic injected into a mold to generate a molded product. In some embodiments, the outer layer and inner layer are made from the same material. In some embodiments, the outer layer and inner layer are made from different material. In some embodiments, the outer layer, inner layer or both comprise an at least one material compatible with plastic injected into a mold to generate a molded product.

In some embodiments, materials compatible with plastic injected into a mold to generate a molded product are selected from a group consisting of high-density polyethylene (HDPE), polypropylene (PP), polyethylene (PE), acrylonitrile butadiene styrene (ABS), polycarbonate (PC), polyamide (PA), polyethylene terephthalate (PET), or thermoplastic polyurethane (TPU) including any combination thereof.

In some embodiments, the inlay layer is configured to perform as a passive electronic communication unit. As used herein, the term “passive communication unit” refers to a device or system that can communicate or transmit data without requiring an external power source to operate its communication functions. This unit rely on energy from the external environment, typically in the form of radio frequency (RF) signals, to power their communication processes. The “passive” nature of the unit means it does not actively generate its own signal but instead reflects or modifies incoming signals to transmit information.

In some embodiments, the inlay layer is characterized by a thickness of between 100 μm and 350 μm, between 150 μm and 350 μm, between 150 μm and 300 μm, or between 200 μm and 300 μm, including any range or value in between. Each possibility represents a separate embodiment of the present invention.

In some embodiments, the inlay layer is a multilayer structure. In some embodiments, the inlay layer comprises (i) an at least two electronic components; (ii) an antenna supporting layer comprising an antenna; (iii) a supporting layer; and (iv) a pressure-sensitive adhesive layer configured to connect between the antenna supporting layer and the supporting layer

In some embodiments, the at least two electronic components independently selected for the group consisting of radio-frequency identification integrated circuit (RFID-IC), near-field communication integrated circuit (NFC-IC), Bluetooth low energy integrated circuit (BLE-IC), or a capacitor.

As used herein, the term “antenna” refers to a device used to transmit and receive electromagnetic waves, typically in the form of radio waves. It is a critical component in wireless communication systems, enabling the transfer of signals between a device (such as a smartphone, radio, or satellite) and the surrounding environment. The primary function of an antenna is to convert electrical signals into electromagnetic waves for transmission or vice versa for reception.

In some embodiments, a method for preparing the inlay layer comprises (i) obtaining or preparing an antenna supporting layer, (ii) obtaining or preparing an antenna; (iii) obtaining or preparing a support layer; and (iv) contacting antenna on one side to the antenna supporting layer and the other side to the support layer.

In some embodiments, connecting is by pressure-sensitive adhesive. In some embodiments, the pressure-sensitive adhesive is stable at temperatures up to at least 140° C. In some embodiments, the pressure-sensitive adhesive is selected from a group consisting of an acrylic pressure sensitive adhesive, a rubber-based pressure sensitive adhesive or a silicone-based pressure sensitive adhesive, including any combination thereof.

A person skilled in the art that the relative high thickness of the pressure-sensitive adhesive compensates for thermal expansion or contraction that occurs in the different layers during the molding process, thereby prevent the distortion of the label or the formation of bubbles after the injection.

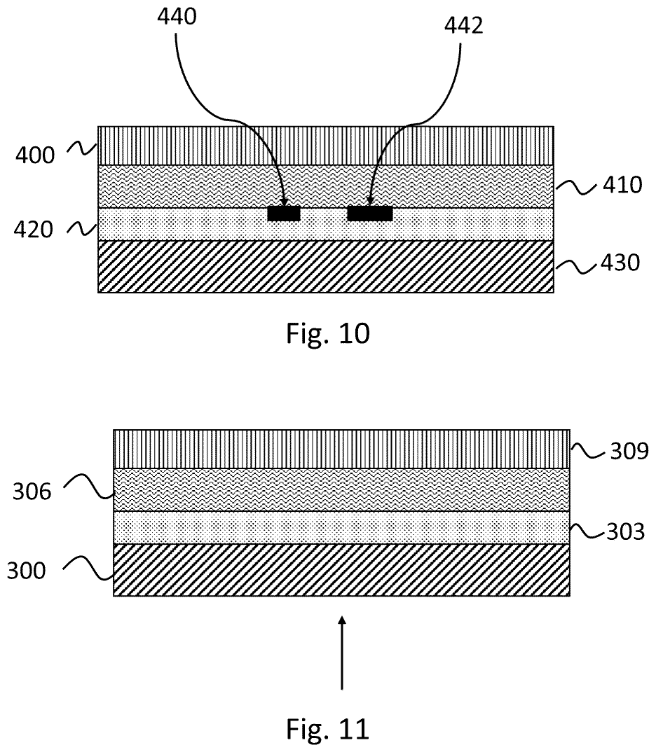

Reference is now made to FIG. 10 presenting illustration of inlay layer according to some embodiments of the present invention. FIG. 10 demonstrates a multilayered structure of the inlay layer. The inlay layer comprises of an antenna supporting layer 400, an antenna 410, a pressure sensitive adhesive layer 420, a support layer 430, and two electronic components 440 and 442. In some embodiments, 440 comprises an IC and 442 comprises a capacitor. In some embodiments pressure sensitive adhesive is or comprises a layer.

In some embodiments, the antenna supporting layer is characterized by a thickness of between 8 μm and 50 μm, between 8 μm and 40 μm, between 8 μm and 35 μm, between 8 μm and 30 μm between 8 μm and 25 μm, or between 8 μm and 20 μm, including any range or values in between. Each possibility represents a separate embodiment of the present invention.

In some embodiments, the antenna supporting layer comprises polyethylene terephthalate (PET), or polyimide (PI).

In some embodiments, the antenna comprises aluminum, copper or conductive In some embodiments, the antenna is characterized by a minimum deflection temperature of 130° C.

In some embodiments, the antenna is characterized by a thickness of between 1 μm and 20 μm, between 1 μm and 15 μm, between 5 μm and 20 μm, or between 8 and 20 μm, including any range or value in between. Each possibility represents a separate embodiment of the present invention.

In some embodiments, a method for preparing an antenna is selected from the group consisting of screen printing, inkjet printing, gravure printing, laminating metal films, or etching including any combination thereof.

In some embodiments, the inlay layer further comprises a primer layer for digital printing. In some embodiments, the primer layer is placed on support layer 400. In some embodiment, the ink is printed on top of the primer layer. In some embodiments, the ink layer is the antenna layer. In some embodiments, the primer layer is characterized by a thickness of between 1 μm and 20 μm.

In some embodiments, the pressure sensitive adhesive layer 420 is characterized by a thickness of between 20 μm and 150 μm.

Reference is now made to FIG. 11 an illustration presenting an exemplary outer layer for PP or PE injected parts according to some embodiments of the present invention. Outer layer 300 comprises of a PP or PE film or sheet. The visual data is obtained printing ink, if the printed ink requires primer, a primer layer 303 characterized by a thickness of between 1 μm and 20 μm is placed on top the outer layer. Then ink is printed, typically forming an ink layer 306 characterized by a thickness of between 1 μm and 10 μm, and a protective layer 309, characterized by a thickness of between 5 μm and 30 μm such as varnish is placed in top. In some embodiments, the visual data printed includes but not limited to variable data, logo, text or digital markers, including any combination thereof.

In some embodiments, the support layer is characterized by a thickness of between 50 μm and 500 μm, between 50 μm and 400 μm between 50 μm and 300 μm, between 100 μm and 500 μm, between 200 μm and 500 μm, between 250 μm and 500 μm, or between 60 μm and 120 μm, including any value or range in between. Each possibility represents a separate embodiment of the present invention.

In some embodiments, the support layer comprises PP, PE, PI, PET, polyethylene naphthalate (PEN), or polycarbonate (PC) including any combination thereof.

A person skilled in the art would appreciate that the polymers comprising the antenna supporting layer 400 and support layer 430 differ according to the injection temperature. High temperature injected polymers include but are not limited to PI, PET, PEN, or PC.

According to another aspect of the present invention there is provided a method of producing a product with an in-mold label comprising steps of (a) obtaining an in-mold label generated by a method using continuous roll to roll process, the method comprising steps of (i) obtaining an outer layer; (ii) printing visual data on an outer side of the outer layer; (iii) obtaining an inner support layer; (iv) placing an inlay layer configured to perform as a passive electronic communication unit; (v) applying a pressure-sensitive adhesive to the inner and outer layers; (vi) placing together the inner layer, the inlay layer and the outer layer with the pressure sensitive adhesive there between; and (vii) bonding together all layers, thereby obtaining the label to be inserted in a mold; the outer layer film or sheet and the inner support film are configured to bond integrally with a product formed by a plastic injectable into a mold; (b) positioning the in-mold layer in a mold; (c) adding a melted plastic to the mold; (d) cooling the plastic; and (e) removing the molded part from the mold.

In some embodiments, the method further comprises a step of holding the IML in a mold. In some embodiments, the holding is by generation of vacuum or static electricity between the IML and a mold. In some embodiments the pressure-sensitive adhesive film is stable at temperatures up to at least 140° C.

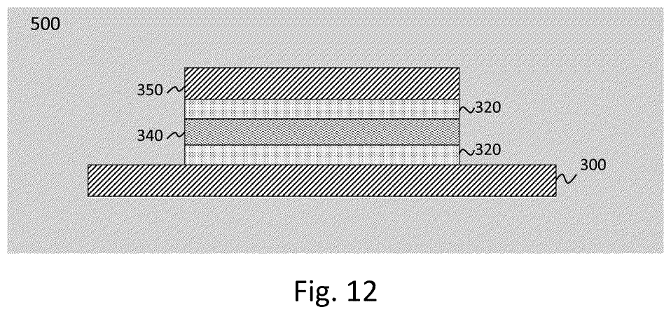

Reference is now made FIG. 12 an illustration showing a side view of an IML according to some embodiments of the present invention, with in a mold. The IML is seen within mold 500. IML comprises of an outer layer 300, a pressure-sensitive adhesive 320, an inlay layer 340, and an inner layer 350. The pressure-sensitive adhesive is configured to connect between the inlay layer and the outer layer and inner layer.

According to another aspect of the present invention there is provided a label for inserting in a mold comprising (a) an outer layer comprising visual data, film or sheet; (b) an inner support layer comprising a film or sheet; and an inlay layer configured to perform as a passive electronic communication unit. In some embodiments, the outer layer, inlay layer and inner support layer are adhered to one another by pressure-sensitive adhesive. In some embodiments, outer layer film or sheet and the inner support film are configured to bond integrally with a product formed by a plastic injectable into a mold.

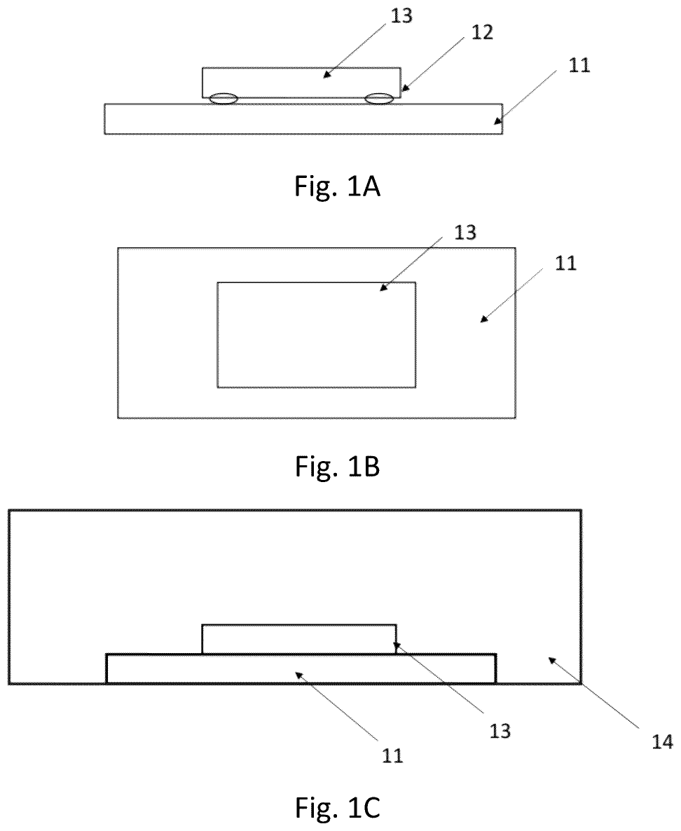

Reference is now made to FIG. 1a-b shows an embodiment of the label, where FIG. 1a shows a side view of the label and FIG. 1b shows a plan view. The label comprises 3 main elements):
An outer layer 11 comprising the visual data (such as graphics, printed words, barcodes, data matrix codes, etc.) printed on outer side. In some embodiments, the outer layer comprises a plastic with high compatibility to the injected plastic (in order to form a strong bond at the area surrounding the electronic element), such as HDPE when PE is used. The outer label has a minimum thickness of 150 μm. The label can be further protected with varnish or lamination.
A liquid adhesive 12, (in some embodiments, a pressure-sensitive adhesive), typically attaches the inner layer and the outer layer to each other. In some embodiments, the amount of adhesive used is approximately 2 drops. In some embodiments, the adhesive is stable at temperatures up to at least 140° C., in other embodiments, it is stable at temperatures up to at least 150° C. The adhesive can be, for non-limiting example, cyanoacrylate, polyurethane, epoxy, silicone, acrylic, rubber, a rubber-based adhesive or a silicone-based adhesive. The liquid adhesives were evaluated by placing 2 dots on the two elements (layers) before being placed in the mold.
An inner layer 13 comprises an electronic element layer, where the electronic element layer comprises the circuits for an electronic communication unit, such as RFID or BLE, that is generated on the outer side of the inner layer 13. In some embodiments, the inner layer comprising the electronic element layer comprises a plastic that is compatible to the injected plastic and has a similar thermal shrinkage. In some embodiments, the horizontal dimensions of the inner layer 13 are smaller than those of the outer layer.

Reference is made to FIG. 1c, showing the two layers of the label 11 13, embedded in the molded plastic 14.

In some embodiments, the RFID tags comprise 2 main elements:
an antenna for receiving and transmitting a signal. The antenna can be produced by printing (with conductive ink), by die cutting (with a metal such as aluminum or copper), by etching (on another carrier) or any other known method
an integrated circuit (IC), such as a microchip, configured to store and process information and modulates and demodulates radio-frequency (RF) signals. The IC can be connected by various methods, such as flip chip and direct chip. In some embodiments, RFID/IC further comprises a non-volatile memory, configured for storing data.

In some embodiments, the antenna and IC are attached to either the outer layer or the inner layer by an adhesive, such as a fast-acting liquid adhesive.

In some embodiments, the IC and/or antenna are constructed as part of a separate layer that can be bound to the inner layer or the outer layer before production of the IML.

The RFID tag can comprise fixed or programmable logic for processing the transmission and sensor data, respectively. Tags can be characterized as read-only (having a factory-assigned ID number), or as read/write (where ID data can be written into the tag by the system user).

The RFID tag can be categorized as passive, active or power-assisted passive. An active tag has a power source (such as a battery), enabling the transmission of its (ID) signal. A power-assisted passive tag has a power source (such as a small battery) and is activated in the presence of an RFID reader. A passive uses the radio energy transmitted by the reader.

The necessary thickness of the outer layer and the inner layer was evaluated:
The outer layer was evaluated at various thicknesses (150 μm, 350 μm and 450 μm): With a thickness of 150 μm, disbonding from the inner layer, such as wrinkles and bubbles, was identified. No wrinkles and bubbles were seen with outer layers at least 150 μm (350 μm and 450 μm) thick.
The inner layer was evaluated at various thicknesses (150 μm, 350 μm and 450 μm): With a thickness of 150 μm, the inner layer sometimes changed shape (such as wrappage and becoming an arc instead of straight line). No shape changes were seen with layers at least 150 μm (350 μm and 450 μm) thick.

### Manufacturing Option 1:

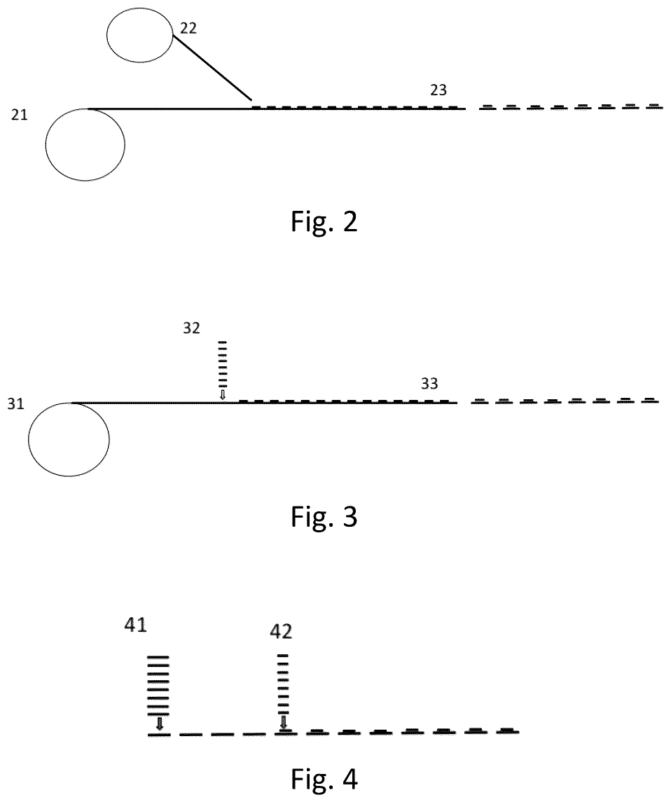

Reference is made to FIG. 2, showing a method of manufacturing the label of the present invention:
The outer layer 21 is printed with the graphics and the variable data.
After printing, the outer surface is covered in order to protect the printing. The cover can be a high resistance varnish or a clear film lamination. The layer can continue as a film in roll format.
The electronic element is fabricated on the inner layer 22. The antenna may be created by printing conductive ink, by die cutting aluminum or copper, by etching, or by lamination of a prefabricated antenna made on a thin film. The IC may be connected to the antenna by any conventional chip attachment method.
The fabricated layer can be laminated to a PSA transfer adhesive tape, and die cut into labels 23.
The labels 23 can be adhered to the back of the outer layer 21.
The electronic element was adhered to the back of the outer layer, and the laminate is die cut into single units

### Manufacturing Option 2:

Reference is made to FIG. 3, showing a process for producing the label of the present invention:
The outer layer 31 is printed with the graphics and the variable data.
After printing, the outer surface is covered in order to protect the printing. The cover can be a high resistance varnish or a clear film lamination. The layer can continue as a film in roll format.
The electronic element is fabricated on the inner layer 32. The antenna may be created by printing conductive ink, by die cutting of aluminum or copper, by etching, or by lamination of a prefabricated antenna made on a thin film. The IC can be connected to the antenna by any conventional chip attachment method.
The fabricated layer can be die-cut into single units 33—the single units can be attached to the back of the outer layer using liquid adhesive or a PSA.
The electronic element was adhered to the back of the outer layer, and the laminate is die cut into single units

### Manufacturing Option 3:

Reference is made to FIG. 4, showing a process for producing the label of the present invention:
The outer layer 41 is printed with the graphics and the variable data. After that the printing is over varnished with high resistance varnish in order to protect the printing. The varnish can be replaced by over lamination clear film. The layer can be die cut into single units.
The electronic element is fabricated on the inner layer 42. The antenna can be created by printing conductive ink, by die cutting of aluminum or copper, by etching, or by lamination of a prefabricated antenna made on a thin film. The IC may be connected to the antenna by any conventional chip attachment method.
The fabricated layer can be die cut into single units—the single units can be adhered to the back of the outer layer using liquid adhesive or a PSA.

### Example 1

In some embodiments, generation of the embeddable RFID tag can comprise the following steps:
1. Generate an RFID comprising an antenna and an integrated circuit.
2. Generate an outer layer for the embeddable RFID tag. Typically, the outer layer will comprise printing on one side.
3. attach the RFID to the label.

Typically, there are a plurality of embeddable RFID tags on each sheet of outer layer material. These can be die-cut into individual embeddable RFID tags, which can then be placed in a mold and embedded in a usable product, as described in more detail below.

### Generating an RFID Attachable to an Outer Layer

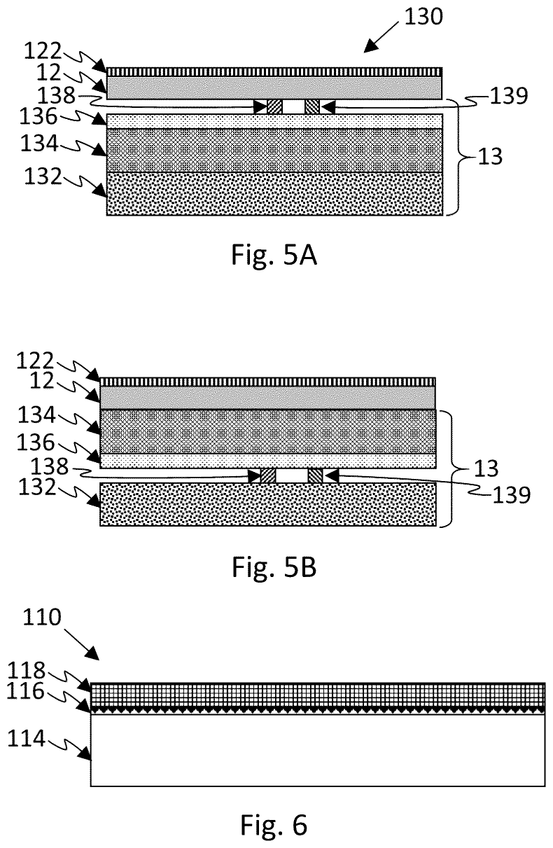

The attachable RFID 130 is shown in FIG. 5A-B.
1. An antenna is provided on a first support sheet 134 that is typically polyester (polyethylene terephthalate, PET). Preferably, the first support sheet is coated with a metal layer, typically aluminum or copper and an antenna 136 is etched in the metal layer. Any conventional conductive antenna material can be used, as can any conventional means of generating an antenna. For non-limiting example, the antenna can be created by printing conductive ink, by die cutting of aluminum or copper, by etching, or by lamination of a prefabricated antenna made on a thin film.
2. An integrated circuit (IC) 138 is attached to the antenna 136, in electrical communication with the antenna, thus generating an electronic communication unit. Any conventional means of attaching the IC to the antenna can be used.

Optionally, a capacitor 139 can be provided, in electrical communication with the electronic communication unit.

Preferably, the thickness of the layer comprising the electronic communication unit 136, 138, (139) is less than 20 μm and the layer comprising the electronic communication unit 136, 138, (139) has a minimum deflection temperature of 130° C.

The electronic communication unit is typically an RFID or a BLE.
3. The first support sheet 134, comprising the electronic communication unit 136, 138, (139), is laminated to a backing sheet 132, thereby generating an RFID 13.

The electronic communication unit 136, 138, (139) can face outward (FIG. 5A) or inward (FIG. 5B). Typically, the backing sheet 132 is high density polypropylene, high density polyethylene or another high-density polyolefin, the material of the backing sheet 132 preferably chosen to be the same as that of the product into which the RFID tag is to be embedded.

The polyethylene sheet can have a thickness in a range from 150 μm to 1 mm; preferably, the thickness is in a range from 250 μm to 1 mm. Preferably, the thickness of the polyethylene sheet is 450 μm. The ensures that, during the molding that generates a product with an embedded RFID tag, the difference in shrinkage between the product material and the RFID tag materials is absorbed by the polyethylene sheet, preventing damage to the antenna or IC. The thick polyester sheet also helps protect the antenna and IC from damage during high-pressure washing of the final product during use.
4. The RFID 13 is typically generated on a roll. Individual RFIDs are now cut from the roll typically by die cutting, although any conventional means of separating a plastic shape from a sheet or roll can be used. Either before or after the RFIDs 13 are separated from the roll, an adhesive 12 is adhered to the electronic communication unit 136, 138, (139), for the antenna-outward configuration (FIG. 5A) or the first support sheet 134, for the antenna-inward configuration (FIG. 5B). Preferably, the adhesive 12 is a pressure sensitive adhesive, although a double-sided adhesive tape or a liquid adhesive, as described above, can be used.

The pressure sensitive adhesive can be any conventional pressure-sensitive adhesive that is stable at temperatures up to at least 140° C., or temperatures up to 150° C.

The free side of the adhesive 12 (the one not adhered to the electronic communication unit 136, 138, (139) or the first support sheet 134) is then adhered to a release liner 122, thereby generating an adherable RFID 130. The release liner is removed when the RFID tag is assembled, as described below.

Preferably, the adhesive is a pressure-sensitive adhesive or transfer adhesive such as, but not limited to, acrylic adhesive, a rubber-based adhesive or a silicone-based adhesive. In the embodiment as shown, the release liner 122 forms a roll, so that the RFIDs 13 adhered temporarily to the release liner 122 roll can be handled using conventional roll handling techniques.

### Generating an Outer Layer

The outer layer 110 is shown in FIG. 6.

Typically, the outer layer 110 comprises a main layer 114 comprising high density polypropylene, high density polyethylene or another high-density polyolefin, the material of the main layer 114 preferably chosen to be the same as that of the product into which the RFID tag is to be embedded. Typically, the thickness of the main layer 114 is 450 μm; the thickness can be in a range from 150 μm to 1 mm; preferably, the thickness is in a range from 250 μm to 1 mm.

The main layer 114 is typically printed on one side with at least one visible indicia 116 such as, but not limited to, a barcode, a matrix code, a logo, a company name, an image, a graphic, a date, or other identifying information.

The printed side preferably becomes the outermost side of the RFID tag, so that the indicia 116 can be easily read by a user.

Preferably, the printing is covered by a protective layer 118, which can be a material such as varnish or can be a sheet laminated to the main layer 114 over the printing.

A plurality of outer layers 110 are typically generated on a roll or sheet and, during assembly, as described below, individual RFIDs tags are cut from the roll or sheet.

### Attaching the RFID to the Label

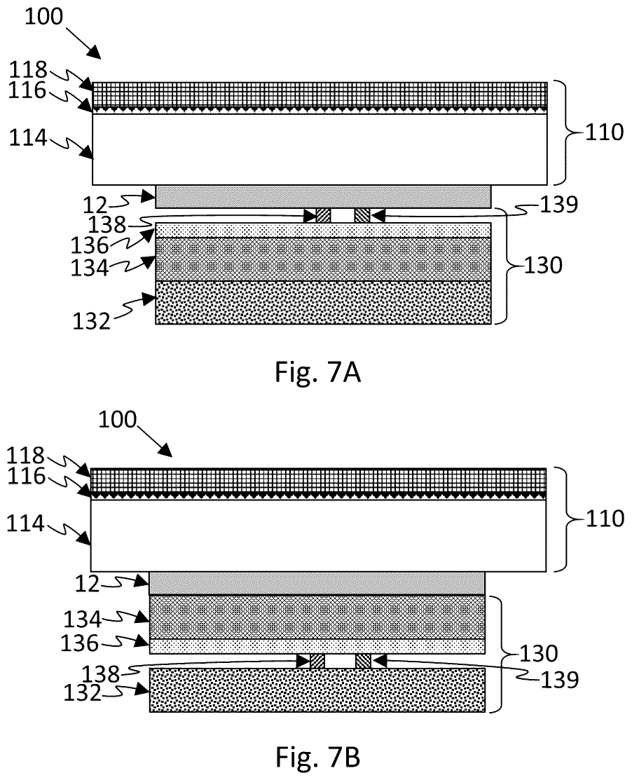

An assembled RFID tag is shown in FIGS. 7A and 7B.

To assemble an RFID tag 100 from an adherable RFID 130 and an outer layer 110, the release layer 122 is removed from the adherable RFID 130 and adhered to the free (unprinted) side of the outer layer 110. Good adhesion can be ensured by pressing the adherable RFID 130 and the outer layer 110 together between rollers; any conventional means of ensuring good adhesion can be used. It should be noted that, at this step, permanent adhesion is not needed. The sheet or roll now comprises a plurality of RFID tags, with each RFID 130 adhered to an outer layer 110 being an RFID tag. The RFID tags are now die-cut or otherwise separated from the remainder of the roll or sheet, generating a plurality of individual RFID tags.

In order to prevent separation of the RFID 130 from the outer layer 110 during use, when the outer layer 110 is separated from the remainder of the roll or sheet, the outer layer 110 is larger on all four sides than the inner layer 130 in other words, the inner layer has a smaller surface area than the outer layer and there is a border of outer layer 110 around all four sides of the RFID. Preferably the border is at least 3 mm wide on all four sides. In some embodiments, the surface area of the inner layer is no more that 95% of the surface area of the outer layer.

In addition, preferably, the antenna has a smaller surface area than the inner layer.

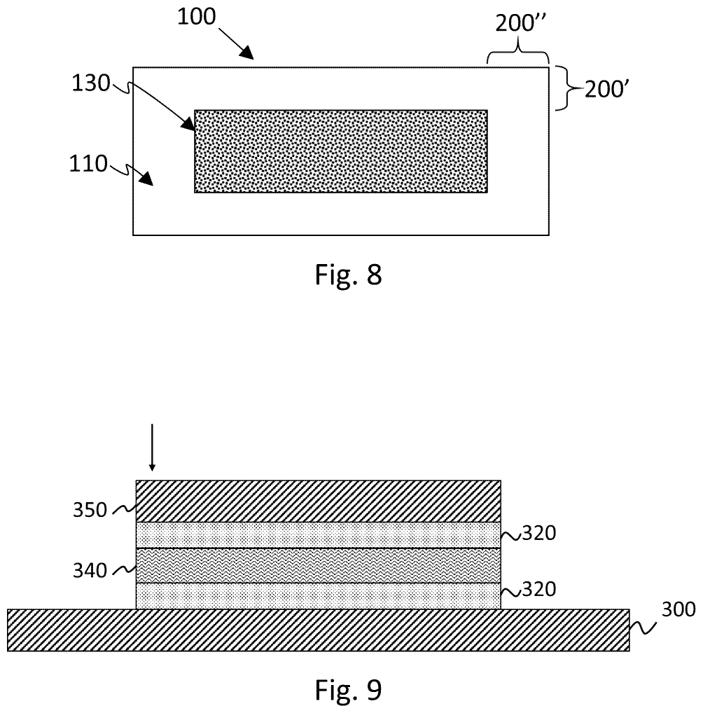

FIG. 8 schematically illustrates an exemplary RFID tag 100. The RFID 130 is surrounded on all four sides by a rim 200′, 200″ of the outer layer 110.

The rim will bond very strongly to the product material so that, even if the product endures heavy use, the outer layer 110 will not disbond from the product, thereby ensuring that the antenna and IC remain protected from the environment by the surrounding product and the overlying outer layer 110, and that the antenna and IC do not disbond either from each other or from the product.

In order to generate a product comprising an RFID tag of the present invention, the RFID tag 100 is placed in a conventional injection molding machine and held against a wall of the conventional injection molding machine by a vacuum between the RFID tag 100 and the wall of the mold, by static electricity at the wall of the mold, by a raised edge in the mold, by any other conventional means of holding a part in a predetermined position in a mold, or any combination thereof. The mold is filled with plastic in the conventional manner and ejected in the conventional manner after cooling, with the RFID securely bonded to it.

Care must, of course, be taken to ensure that the backing sheet 132 and the outer layer 110 are of the same material as the product, as this ensures that the RFID tag 100 will become an integral part of the product. For non-limiting example, crates, boxes and skids for heavy-duty use are typically polypropylene, high-density polyethylene or another high-density polyolefin. For non-limiting example, for a heavy-duty crate of polyethylene, the backing sheet 132 and outer layer 110 would be polyethylene. However, other than changing the material, few if any changes would need to be made to the production process for generating the RFID tags 100.

Another advantage of the RFID tag 100 of embodiments of the type of Example 1 is that no molding is used in the production of the RFID tags, so that the antenna and IC only need protection from high temperatures during the molding process that embeds them in the product.

The outer layer and the inner layer can comprise material selected from a group consisting of HDPE, PP, PE, ABS, PC, PA, PC and PET.

What is claimed is:

1. A method for manufacturing an in-mold label (IML) using a continuous roll to roll process, said method comprising steps of:
a. obtaining an outer layer, said outer layer comprising a film or sheet, characterized by a thickness of between 200 μm and 1000 μm;
b. printing visual data on an outer side of said outer layer;
c. obtaining an inner support layer comprising a film or sheet, characterized by a thickness of between 200 μm and 1000 μm;
d. placing an inlay layer configured to perform as a passive electronic communication unit, characterized by a thickness of between 100 μm and 350 μm.
e. applying a pressure-sensitive adhesive to said inner and outer layers, characterized by a thickness of between 80 and 150 microns;
f. placing together said inner layer, said inlay layer and said outer layer with said pressure sensitive adhesive there between; and
g. bonding together all layers, thereby obtaining said label to be inserted in a mold;
said outer layer film or sheet and said inner support film are configured to bond integrally with a product formed by a plastic injectable into said mold;
wherein said inlay layer comprises
i. at least two electronic components independently selected for the group consisting of radio-frequency identification integrated circuit (RFID-IC), near-field communication integrated circuit (NFC-IC), Bluetooth low energy integrated circuit (BLE-IC), or a capacitor;
ii. an antenna supporting layer comprising an antenna;
iii. a supporting layer; and
iv. a pressure-sensitive adhesive layer configured to connect between said antenna supporting layer and said supporting layer.

2. The method of claim 1, wherein said printing further comprises printing invisible data, color changing materials, or both; configured to enable package identification, monitor environmental changes, or both.

3. The method of claim 1, further comprising a step of providing a protective layer on an external side of said outer layer, selected from a group consisting of a varnish or a protective sheet laminated to said external side.

4. The method of claim 1, wherein said pressure-sensitive adhesive is stable at temperatures up to at least 140° C., selected from a group consisting of an acrylic pressure sensitive adhesive, a rubber-based pressure sensitive adhesive or a silicone-based pressure sensitive adhesive, including any combination thereof, or both.

5. The method of claim 1, wherein said outer layer and said inner layer comprise materials compatible with plastic injected into a mold to generate a molded product selected from a group consisting of high-density polyethylene (HDPE), polypropylene (PP), polyethylene (PE), acrylonitrile butadiene styrene (ABS), polycarbonate (PC), polyamide (PA), polyethylene terephthalate (PET), or thermoplastic polyurethane (TPU) including any combination thereof.

6. The method of claim 1, wherein said visual data is selected from a group consisting of a graphic, a printed word, a barcode, a data matrix code or any combination thereof.

7. The method of claim 1, further comprising preparing said inlay layer by preparing said antenna supporting layer comprising said antenna; preparing or obtaining a supporting layer; and connecting between said antenna supporting layer with said antenna and connecting said antenna with said supporting layer.

8. The method of claim 1, wherein said antenna is characterized by a thickness between 8 μm and 50 μm, a minimum deflection temperature of 130° C., or both.

9. The method of claim 1, wherein said outer layer fully surrounds said inner layer and forms a border characterized by a width of at least 3 mm on all four sides of said inner layer.

10. A label for inserting in a mold comprising
a. an outer layer comprising visual data, film or sheet, said outer layer characterized by a thickness of between 200 μm and 1000 μm;
b. an inner support layer comprising a film or sheet, characterized by a thickness of between 200 μm and 1000 μm;
c. an inlay layer configured to perform as a passive electronic communication unit, characterized by a thickness of between 100 μm and 350 μm;
said outer layer, inlay layer and inner support layer are adhered to one another by pressure-sensitive adhesive; and
said outer layer film or sheet and said inner support film are configured to bond integrally with a product formed by a plastic injectable into a mold;
wherein said inlay layer comprises
i. at least two electronic components independently selected for the group consisting of radio-frequency identification integrated circuit (RFID-IC), near-field communication integrated circuit (NFC-IC), Bluetooth low energy integrated circuit (BLE-IC), or a capacitor;
ii. an antenna supporting layer comprising an antenna;
iii. a supporting layer; and
iv. a pressure-sensitive adhesive layer configured to connect between said antenna supporting layer and said supporting layer.

11. The label of claim 10, wherein said outer layer comprises invisible data, color changing materials, or both; configured to enable package identification, monitor environmental changes, or both.

12. The label of claim 10, wherein external side of said outer layer comprises a protective layer selected from a group consisting of a varnish or a protective sheet laminated to said external side.

13. The label of claim 10, wherein said pressure-sensitive adhesive is stable at temperatures up to at least 140° C., selected from a group consisting of an acrylic pressure sensitive adhesive, a rubber-based pressure sensitive adhesive or a silicone-based pressure sensitive adhesive, including any combination thereof, or both.

14. The label of claim 10, wherein said inlay layer is obtained by preparing said antenna supporting layer comprising said antenna; and connecting between said antenna supporting layer with said supporting layer.

15. The label of claim 10, wherein said antenna is characterized by a thickness between 8 μm and 50 μm, a minimum deflection temperature of 130° C., or both.

16. The label of claim 10, wherein said outer layer fully surrounds said inner layer and forms a border characterized by a width of at least 3 mm on all four sides of said inner layer.

17. The label of claim 10, wherein said outer layer is larger than said inner layer, the difference in size selected from a group consisting of (i) said inner layer has a smaller surface area than said outer layer; or (ii) the surface area of said inner layer is no more that 95% of a surface area of said outer layer.

18. The label of claim 10, wherein said antenna has a smaller surface area than said inner layer.
